(19) United States
(12) Patent Application Publication
(10) Pub. No.: US 2018/0193223 A1
(43) Pub. Date: Jul. 12, 2018

(54) Mobile Vehicle With Water Bathing Facility For Entertainment Purposes, Vehicle-Mounted Water-Level Controlling System For Bathing-Pool Filled With Water, And Method Of Application Of Said System

(71) Applicant: Bela Gal, Budapest (HU)

(72) Inventor: Bela Gal, Budapest (HU)

(21) Appl. No.: 15/741,176

(22) PCT Filed: Jun. 22, 2016
(86) PCT No.: PCT/HU2016/000039

§ 371 Date: Dec. 29, 2017

(30) Foreign Application Priority Data
Jun. 29, 2015 (HU) P1500300

(51) Int. Cl. A61H 33/00; E04H 4/00; E04H 4/12; E04H 4/14; B60P 3/36; B60R 15/04; B60R 15/02; B60J 7/043

(52) U.S. Cl. CPC A61H 33/005; A61H 2201/5082; E04H 4/1245; E04H 4/129; E04H 4/14; A61H 33/0087; A61H 33/0095; A61H 33/6005; A61H 33/6021; B60P 3/36; B60R 15/04; B60R 15/02; B60J 7/043; A61H 2033/0037; A61H 2201/02; A61H 2201/0119; E04H 4/0018

(57) ABSTRACT

The invention relates, on the one hand, to a mobile vehicle with water bathing facility for entertainment purposes that comprises at least one suitable motor vehicle, an either open or covered pool (m) mounted on this vehicle as a superstructure or converted from the body of the car where the pool (m) concerned is filled with water, and where the water-level control to suit the current road conditions is executed by means of the screw jacks (h), hydraulic or pneumatic cylinders (h), effectuated by a pool-moving unit (1), and the stability of the water mass swaying on account of braking and acceleration is ensured by the flood diverting unit (2) and water flow and sway controlling unit (3). The aforesaid units together with the central control unit (v) constitute one system, which is the water-level controlling system (6) of a pool (m) filled with water that is mounted on a motor vehicle. On the other hand, the invention relates to an application for transportation of people in a pool (m) mounted on a motor vehicle and filled with water which vehicle is utilised as a sightseeing bus comprising the complete range of services provided by the mobile bathing vehicle, such as sightseeing tours, bachelor parties, hen nights, school trips and any function or social event.

### FIELD OF THE INVENTION

The invention relates partly to a m pool mounted on a motor vehicle and filled with water as well as the 6 water level controlling system of this m pool controlling the water level in moving vehicle, and partly to the application of this vehicle for transportation of people in the m pool filled with water, for example using it in sightseeing buses.

### Description of Prior Art

Document No. EP 1671686 A1—relates to a watercraft for entertainment purposes inside a closed building flooded with water with the said watercraft moving along a fixed track. The people are seated in the said watercraft. The watercraft floats on the water, fixed with articulated brackets and steel cables. The solution given in this document bears only as much resemblance to the present invention that is uses similar articulated brackets and cylinders in order to move the watercraft in the course of its glissade along the cableway.

Document No. CN203736837U U 20140730—deals with a rack moving in three dimensions to be used in a movie theatre in order to allow the spectators to experience what is happening in the film in form of movements in addition to the visual experience. The solution given in this document is similar to present claim insofar it uses cylinders and moves in three dimensions.

Document No. US005967583A—relates to a bus, which, as it can be seen from the title, is actually a camper van. All the resemblance it shows with the present claim is that it has a pool mounted on it. The said pool is static, i.e. it is fixed on top of the van above the driver's cabin. According to the description, the pool is filled up only when the vehicle is stationary. The pool cannot contain water when the vehicle is moving, the description does not refer to any technical solution as to holding the water within the pool. The document does not refer to the way of filling the pool with water, of draining the water off, nor does it have any water cleaning equipment. According to the description the motor vehicle was designed to be used on motorways, which also corroborates the presumption that the pool was not designed to be filled with water while the car is on the move, but only when the vehicle is stationary, for example in a campsite.

The website tagged D1 revealed by the innovation research is an article published on the 9^{th} of July, 2014 on the website “mail online”. The article demonstrates a Cadillac automobile with a built-in pool. The pool is fit up with water circulating pump and water nozzles. These accessories are installed in the car boot. The pool does not contain seats, which means that it probably was not designed to be used in traffic. The pool is statically fixed, the water-level control is not ensured, which is well shown in the attached video footage where a slow braking at about 10 km/h causes a significant swaying of the mass of water. Moreover, as the vehicle lacks seats, the people in the pool are exposed to significant inertia even in the case of such slight braking. This can be well perceived by observing the displacement of the driver. The driver is pushed intensely forward, although he can brace himself against the steering wheel. The vehicle described in the article is unsuitable for road traffic with a pool filled with water.

Document No. WO2008145407A1—relates to a sightseeing bus with seats arranged in such a manner that every passenger has a perfect view frontwards. For this purpose the seats are arranged so that each row is higher than the one in front of it so that the passengers get a perfect forward view unobstructed by the passengers sitting in front of them.

Document No. EP2008019446—relates to an air suspension system for vehicles dealing with a level control device, which is an air suspension operating by means of compressed air for the purpose of the level controlling of motor vehicles and trailers.

Document No. EP 20060007972—relates to a switching valve designed for use in appliances for raising and lowering vehicle bodies. The appliances used for this purpose are primarily air suspension systems. Such air suspension systems are suitable for raising and lowering vehicle bodies. The claim relates to a more convenient and safer way of operating the switching valve.

Document No. US2012139299—relates to a sliding roof designed for sightseeing buses and other vehicles. The said roof has a pivot system and its purpose is to ensure clear view for the tourists in the bus, which is most useful in narrow streets and among tall buildings.

Document No. CN201343014—relates to a sightseeing bus equipped with tables and chairs with room enough to move around among them. Family members or smaller parties can sit around the tables. The claim also relates to the satisfactory solution of the heating and the sound technique for listening to music for entertainment.

Document No. CN2586615—relates to a vehicle converted to be suitable for catering which can be used as sightseeing bus as well, but set up on location, it can also be used as a diner in fairs or for workers in plants. The invention also puts emphasis on the importance of environmental protection and the proper waste utilization.

### Presentation of the Problem to be Solved by the Present Invention

The problem that the present invention is intended to solve is the controlling of the water level in overall road and traffic conditions in a m pool filled with water, which pool is mounted on a slowly moving vehicle, especially on a sightseeing bus, and transportation of people in m pool filled with water for the purpose of entertainment, sightseeing or other social occasions. The invention is based on the recognition that in case of an open m pool that is mounted on a vehicle and which pool is filled with water, most of the water spills out of them pool while the vehicle is moving downhill or uphill or during braking, accelerating or cornering, on account of the centrifugal force. The primary task is to devise a 6 water level control system that ensures that the water is contained in the m pool despite the acting forces, and the water level is kept steady. According to our calculations, if one takes a m pool about 1 metre deep and the edge of the wall of the said pool is not more than 200 millimetres above the water level at rest, an instance of braking of 0.5 g strength causes 40-50% of the water in the m pool to spill out from the pool, but even in standard traffic conditions involving 0.2 g-0.3 g deceleration or acceleration, a significant amount of water is spilled out. The coordinated operation of the system comprising the four main units of the invention is capable of containing the water in the m pool despite the above mentioned forces. Furthermore, this 6 water-level controlling system and the m pool are to be built in a motor vehicle, especially in a bus, and to be operated.

### Solution of the Problem

The invention relates partly to a mobile vehicle for entertainment with pool containing water for bathing that comprises at least a suitable motor vehicle, an either open or covered m pool mounted on this vehicle as a superstructure or converted from the body of the car where m pool is filled with water, the water level of the m pool is stabilised while the vehicle is in motion according to the prevailing road conditions. The backward or forward flow of the mass of water caused by braking or acceleration is slowed down, kept at a steady level, and the strong swaying of the water is prevented by applying several methods. Firstly, by the 1 pool moving unit, secondly, by the 2 flood diverting unit, thirdly, by the 3 water flow and sway controlling unit and the v central control unit. The 6 water level controlling system of mobile vehicles consists of these four main units.

1 Pool Moving Unit

While the vehicle is moving, the water level control of the m pool is partly executed by the 1 pool moving unit by means of h screw jacks or h hydraulic or h pneumatic cylinders fitted between the pool and the chassis as well as by the connecting brackets and joints. These h cylinders are two or more h cylinders set at the corners of the m pool or in middle position, which are able to lift or lower the m pool filled with water quickly, as required, according to the signals of the v central control unit, allowing for the water level to be controlled in due measure. This controlling is necessary on the one hand when the road conditions change, namely the vehicle is moving uphill or downhill. In these conditions the water flows forwards or backwards, and it is liable to spill over the wall of the pool. In such cases, by operating the respective h cylinder or several h cylinders simultaneously, one side of the m pool is lifted relative to the chassis of the vehicle allowing the correct adjustment of the water level. On the other hand, there is need for the water level control when the traffic conditions make it necessary, namely when braking, accelerating or changing direction. Gravitation always forces the fluid to fill in the m pool with its surface being horizontal, even when the m pool is tilted. The gravity acceleration is 1 g, that is about 10 m/s², this is the force that keeps the fluid in the m pool and keeps us on the ground. If a hypothetical pool is forced onto a circular track, the water will be kept in the pool by the centrifugal force, as it were, pressed against the bottom of the pool. The 1 pool moving unit utilises this law of physics, that is, operating the respective h cylinders at the right moment so that the surge of water is, so to say, countered. This phenomenon served as the basic idea for creating the 1 pool moving unit. In practical tests we suspended a pool filled with fluid on a mobile car structure, and exposed it to acceleration and deceleration of different values. As a matter of course, a m pool with people in it can only be tilted within limits. This is the reason why present invention comprises additional units as well.

2 Flood Diverting Unit

The second feature of the invention is characterised by the special design of the front and rear f walls of the m pool. Under the said special design a raised part of the wall is understood, which is semicircular in cross section, aimed to change the direction of the water surge and return the water into the m pool along a circular path. This shape allows the flowing water to return to the inside area of the m pool, reversing the direction of the flow. This shape makes it possible for the water gushed out on account of the water's inertia caused by the acceleration and deceleration of the moving vehicle to be channelled back into the m pool. The front f wall is equipped with an automatically opening one-way swinging gate placed above the water level measured at standstill, while the vehicle is stationary, and whose purpose is to ensure that in case of a surge, typically while braking, the water can flow only in one direction, exclusively towards the w floodspace and prevent backflow, thus forcing the water to flow through the b water deflecting lamellae and change direction. The water is diverted into lateral direction and forced to change direction by means of the specially curved b water deflecting lamellae behind the s swinging gate, installed in the w floodspace. From here the water flows back into the m pool via the cs return channels of flood space lodged along the right and left side of the m pool. For safety reasons, the w floodspace equipped with b water deflecting lamellae is covered with d grilled protective casing. The said d grilled protective casing may be made of metal or plastic.

3 Water Flow and Sway Controlling Unit

The third solution utilises the k water inlet channels and n water outlet channels installed in the m pool below the water level. In this solution a sz high performance pump is used to quickly move the water of the m pool swaying due to inertia caused by the movement of the vehicle, to the spaces short of water. The sz high performance pump is operated according to the 3 water flow and sway controlling unit as shown in FIG. 2. This 3 water flow and sway controlling unit senses the movements of the vehicle, such as acceleration, deceleration, lateral tilt, and it adjusts the water level by choosing and operating the appropriate n water outlet channels and k water inlet channels along the lateral sides of the m pool to compensate for the swaying of the water. The 3 water flow and sway controlling unit is capable of transferring large amounts of water quickly and in the required direction from one part of the m pool into another part of it. Its operation is represented by the water swaying caused by braking. In the wake of heavy braking the water in m pool flows to the front wall of the m pool, in the direction of travel, at the same time it is forced by inertia to surge upwards. At this point of time the j valves of the n water outlet channels on the frontal wall of m pool open up at the electrical signal of the v central control unit processing the signals from the sensors installed in the vehicle. The water is transferred into one or several t surge tank/tanks, thus decreasing the amount of water congested in the front part of the m pool, and simultaneously, it is forced to flow downwards. At the same time, the previously drained water is injected by the sz high pressure pumps through the k water inlet channels located in the middle section of the bottom plate of the m pool, slowing down the forward movement of the water caused by inertia. Since the control signal comes from the vehicle, there is enough time to manage the delayed reaction of the mass of water in the m pool. By “the signal coming from the vehicle” we mean that the change in the brake pressure triggers the control signal, the v central control unit controls the speed of the sz high pressure pump according to this signal, and accordingly, the amount of the transferred water, and the program controls the extent and time span of the opening and closing of the appropriate n and k channels as well. The time gain results from the time required for the water to begin to gush to the frontal part of them pool at braking, while then water outlet channels on the front wall have already started to open up. As a matter of course, the program of the v central control unit also contains a secondary routine that evaluates the signals of the water-level sensors in the m pool, because the amount of the water to be controlled changes due to engine braking effect, changing direction, movement of people within the m pool as well as the action of the 1 pool moving unit and the 2 flood diverting unit. By activating the individually controlled v valves the diameter and the opening time interval of each n water outlet channel can be precisely controlled. According to preliminary calculations, the seats fixed in the space of m pool significantly reduce the swaying motion of the water, functioning, as it were, as a breakwater.

v Central Control Unit

The v central control unit is a control unit that consists of 5 water level sensors, 9 signallers, a computer and computer program destined to coordinate the functioning of the different water level controlling units, namely the 2 flood diverting unit, the 1 pool moving unit, and the 3 water flow and sway controlling unit. The v central control unit processes the information coming from the 5 water level sensors and the 9 signallers as well as runs the preset controlling program. The main principle of the complex functions of the control program has two main components. One of the said components is a pre-programmed, constant water-level controlling routine using the pre-programmed data which had been measured at different instances of acceleration, deceleration and changes of direction. The other component is a set of variables derived from the current situation. The sensors installed to evaluate the current situation are capable of modifying, so to speak overwriting the steps of the constant water-level controlling routine within certain limits. These sensors monitor the tilt, the acceleration, the deceleration, the water temperature and the water quality. The different units form a hierarchy, which means that for instance in the first cycle of water controlling the 2 flood diverting unit and the 1 pool moving unit are operating in parallel, and the 3 water flow and sway controlling unit starts working only after the other two units. In case of light deceleration, acceleration or cornering the partial execution of the first cycle is sufficient to control the swaying of water, based on our calculations, the 2 flood diverting unit and the 1 pool moving unit are often enough to fully control the water level of the m pool, it is not always necessary to operate the 3 water flow and sway controlling unit. The mass and movement of the people staying in the m pool, the unpredictable changes of road traffic may of course necessitate operating the 3 water flow and sway controlling unit as well, for example in case of emergency braking. The controlling program is finely scaled, which allows precise controlling.

The adjustment of the water level in m pool and keeping the water level constant independently of the road conditions and any circumstances can be ensured by the individual or combined operation of all the units of the 6 water-level controlling system of the m pool mounted on mobile motor vehicle as previously discussed. On the other hand, the invention relates to the application comprising the whole range of services performed using the mobile vehicle with water bathing facility. A few examples of the services without a claim for completeness are: conducting sightseeing tours, social events, e.g. birthdays, wedding parties, bachelor parties, hen nights etc. For example, a sightseeing tour is similar to the usual services of sightseeing buses except that the tourist, having boarded the bus, change into bathing costumes/trunks, and besides admiring the sights while sitting in a m pool with pleasant water enjoying hydromassage, Jacuzzi or bubble bath, they have the possibility to have meals and/or beverages. The said vehicle may be any vehicle with permission to be used in road traffic. This specially converted vehicle may be primarily a bus, recreational vehicle, semitrailer with attached superstructure, truck, van, or any automobile with removable superstructure or with a car-body that can be converted in a manner to allow a m pool to be installed and contain water. The passengers stay in this m pool and while bathing in the slowly moving vehicle, they enjoy the view and the attractions of the city, and they can listen to tour guides in several languages. The m pool is equipped with facilities for bathing, back massage and different refreshing devices. Thanks to the technical solutions and setting up the background service, the mobile bathing vehicle offers hygienic and professional service for the customers in winter and summer alike. The background service consists of one or more lockable buildings, premises where the mobile vehicle with water bathing facility can be parked and the passengers can get on or off the vehicle, furthermore, in the said building there is a waiting room, changing rooms, shower rooms, toilets and any other rooms required for professional service. In order to provide full-scale service for the customers, it is possible for the passengers to get on or off the mobile vehicle with water bathing facility not only at the premises but also at any point of the city, that is, in the street. The passengers can get on or off anywhere at the scheduled and advertised stops, the design of the mobile vehicle with water bathing facility caters for all the needs of the passengers, such as changing of clothes, storage of clothes, overall hygienic service, for example the vehicle contains changing room, shower, toilet, clothes-storing unit, locker. The technical solutions of the mobile vehicle with water bathing facility allow raising the temperature of the m pool and keeping the temperature at a constant level to such a degree that the people in the water feel comfortable even in cold winter. In summer the water can be kept at a pleasant, refreshing temperature. In winter, the heat produced by the car engine is primarily used for the heating of the m pool, but additional heat input is also ensured by installed technical solutions. The space inside the m pool allows for special plastic seats to be installed, these seats, due to their sufficiently flexible material provide proper protection and pleasant feel to the touch. These seats are constructed in such a manner that they can be easily removed individually, which provides the m pool with extraordinary versatility, that is, free spaces of different size can be created inside the m pool. The injection of air into the water, which is the basic element of a Jacuzzi system, is primarily accomplished by an air compressor powered by the car engine. The regulation of the standard water level, that is, the water level measured when the car is in a stationary position, is performed by means of c spillways, the e water outlet tunnel and the g circulation pump. This ensures that the m pool has a stretched water surface, which means that the spilt water is trapped and then returned into the m pool through the 8 water filtering system.

### LIST OF FIGURES

FIG. 1 is the side view of one possible embodiment of the invention, a mobile bathing-pool vehicle converted from a bus.

FIG. 2 is a side-view schematic of the m pool, parts of the 2 flood diverting unit, parts of the 3 water flow and sway controlling unit and the 1 pool moving unit as a complete system as well as certain additional parts of the system, such as the t surge tanks, v central control unit, sz high pressure pumps, p air compressor 8 water filtering system and g circulation pump.

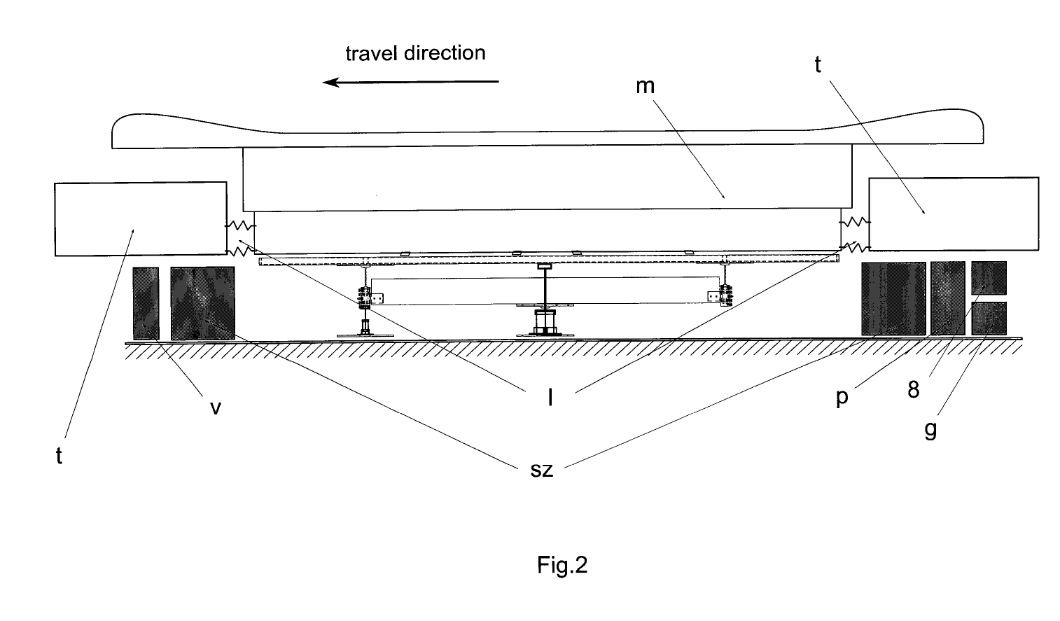

FIG. 3 shows the structure of the 2 flood diverting unit and that of the 3 water flow and sway controlling unit in three views, and the perspective representation of the s swinging gate. The 2 flood diverting unit comprises the f curved wall, d grilled protective casing, b water deflecting lamellae, cs return channels of flood space and s swinging gate. The 3 water flow and sway controlling unit comprises n water outlet channels, k water inlet channels and r protective grille. The figure shows the basic overflow system of m pool needed to ensure the stretched water surface: the e water outlet tunnel and c spillways.

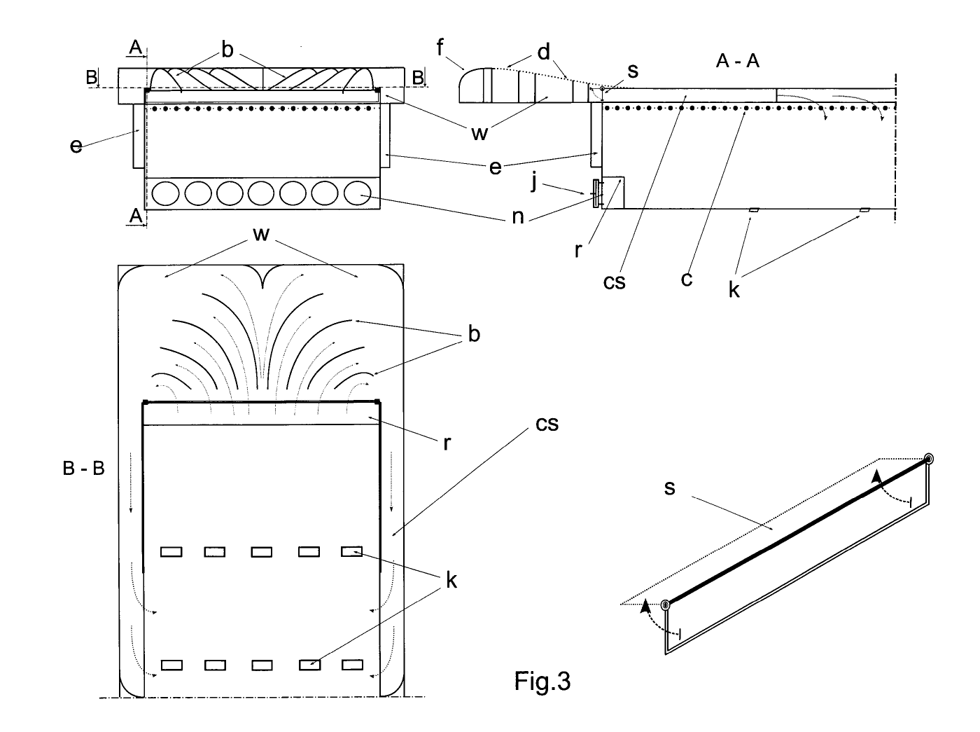

FIG. 4 shows the 1 pool moving unit by way of example with two h hydraulic cylinders, with u longitudinal axis and z cross axis, with articulated suspension, gy bearings y bearing blocks and x object carrier.

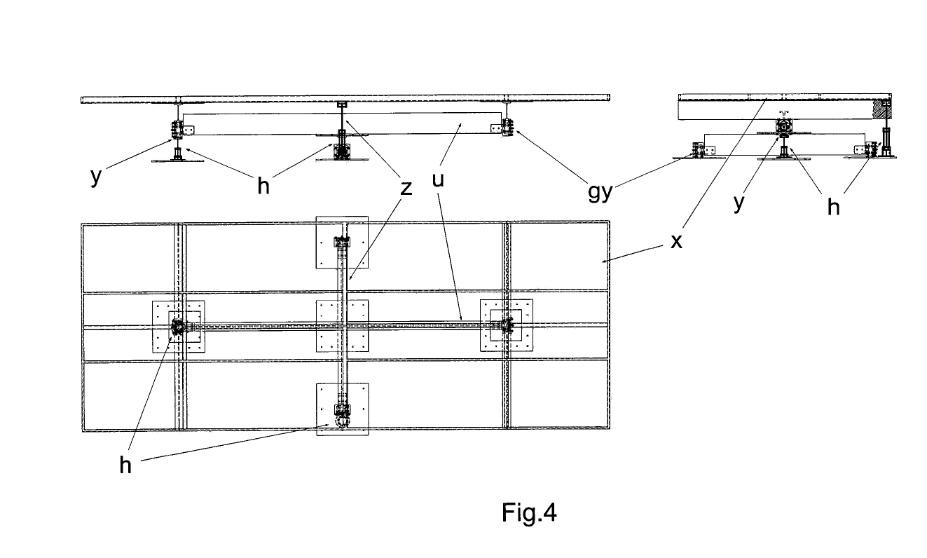

FIG. 5 is the conceptual flowchart of the water level control of the m pool filled with water installed on a mobile vehicle.

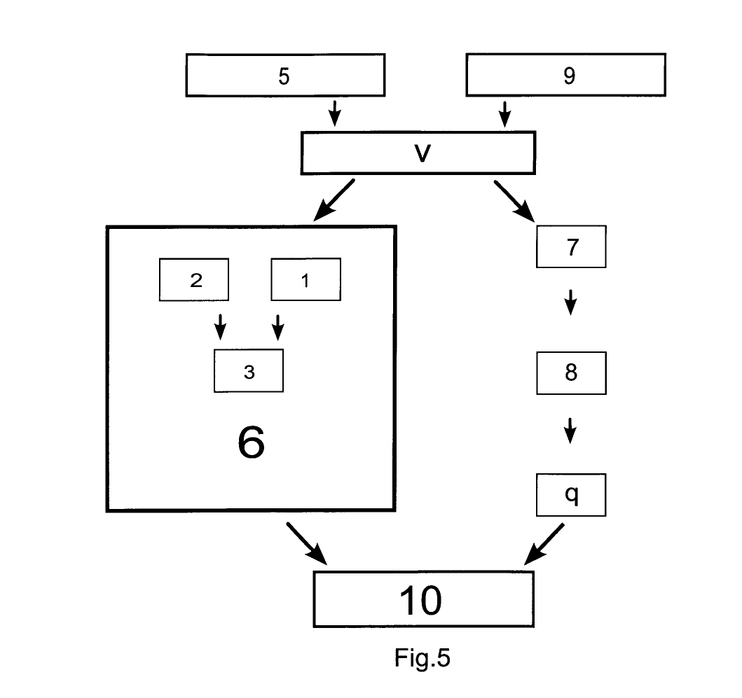

### DESCRIPTION OF THE EMBODIMENT OF THE INVENTION

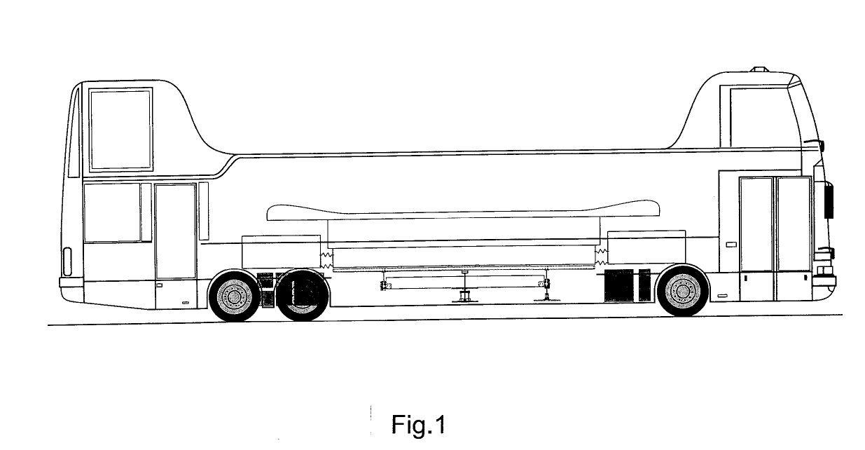

FIG. 1 shows the sketch of a practical implementation of the invention. In our case the vehicle is a bus with half-covered design, the sidewalls are of standard factory design with large, contiguous glass panes, but the bus can have open sides up from the top of the m pool. The roof can be fitted with a sunroof which can be slid from the open section of the roof. The sunroof slides by means of a special, custom-designed guide rail system. Two articulated h cylinders are fixed onto the vehicle's chassis. These h cylinders support the front and the side of the m pool. The said h cylinders turn, relative to the chassis, the x object carrier joined to the u longitudinal and z cross axes by means of the gy bearings. The x object carrier bears the m pool, certain units of the 6 water-level controlling system and other additional equipment. The t surge tanks are fixed to the chassis, they do not move together with the m pool, they are connected with flexible tubes. The changing rooms are installed in the front and rear parts of the upper deck of the vehicle, from where one gets a view of the m pool though a glass wall. The passengers can get on and off the vehicle through the front and rear doors.

### The Advantages of the Invention, its Novelty Compared to the Present State of the Art

The additional advantage of the application described by the invention is that contrary to the currently used sightseeing buses it allows the tourists to see the sights while travelling in a m pool filled with water of pleasant temperature, and to listen to the tour guide. A beneficial new feature is the fact that the equipment installed in the m pool providing foot massage, back massage and other wellness equipment actively help to meet the tourists' requirements for entertainment and relaxation. Besides, the water-level controlling system for regulating the water level of a m pool containing water and people, as part of the present invention is a distinctive solution compared to the present state of the art. The invention ensures that the level of the water and the position of the m pool remain unchanged in the moving vehicle regardless of the road and traffic conditions by means of the h screw jacks or hydraulic or pneumatic h cylinders raising and lowering the m pool, as well as by means of changing the rate, amount and direction of the water pumped out or into the m pool at every moment of time according to the signals from the sensors. Another novelty is returning the surge water into the m pool using the w floodspace, the specially shaped f curved wall at the front and the back sides of the m pool and the b water deflecting lamellae. The combined use of the above mentioned features in a single system, that is, the 6 water-level controlling system cannot be found in other fields known at the present state of the art, the problem does not have an evident solution. None of the explored documents recognized this problem.

### LIST OF ITEMS

1 pool-moving unit

2 flood diverting unit

3 water flow and sway controlling unit

5 sensors

6 water-level controlling system

7 jacuzzi system

8 water filtering system

9 signallers

10 pool water level control

b water deflecting lamellae

c spillways

cs return channel of flood space

d grilled protective casing

e water outlet tunnel

f curved wall

g circulation pump

gy bearing

h cylinder

j valves

k water inlet channels

l flexible ducts

m pool

n water outlet channels

p air compressor

q water heating-cooling system

r protective grille

s swinging gate

sz high pressure pump

t surge tank

u longitudinal axis

v central control unit

w floodspace

x object carrier

y bearing block

z cross axis

1. Mobile vehicle for bathing and entertainment purposes that comprises at least one bathing pool (m), pool moving unit (1), comprises water flow and sway controlling unit (3), comprises central control unit (v), comprises air compressor (p), circulation pump (g), the pool (m) comprises water filtering unit (8), water and air injecting nozzles and spillways (c) characterised in that the pool (m) is fixed on the object carrier (x), said object carrier (x) is attached to the vehicle's chassis via the pool moving unit (1), the pool (m) comprises flood diverting unit (2) as well as water-heating unit, water-cooling unit, waist- and back massage equipment with water- and air inject nozzles, the pool (m) contains individually removable seats, these seats can be equipped with seatbelts, the vehicle comprises at least one changing room, a lavatory, shower room and locker.

2. Mobile vehicle for bathing and entertainment purposes according to claim 1 characterised in that the pool (m) may be made of non-transparent material or some kind of transparent material, the vehicle may have open, covered or partly covered roof, or it may comprise a sliding sunroof over the pool (m).

3. Mobile vehicle for bathing and entertainment purposes according to any of claims 1-2 characterised in that the vehicle may be a bus or coach, semitrailer, truck, automobile, or any motor vehicle with permission to take part in road traffic, the vehicle is equipped with steps, passageways or ramps covered with slip-free material, and the vehicle has at least one sewage tank.

4. Pool moving unit (1) of mobile vehicle for bathing and entertainment purposes according to any of claims 1-3 characterised in that it comprises at least one screw jack (h), pneumatic cylinder (h) or hydraulic cylinder (h), it comprises articulated suspension parts and brackets, bearings (gy), bearing blocks (y), longitudinal axis (u), cross axis (z), it comprises an object carrier (x) with at least one cylinder (h) joined to the object carrier (x) and to the chassis, and with at least one cylinder (h) joined to the a bearing block (y) and to the chassis, allowing the object carrier (x) to move in three dimensions.

5. Flood diverting unit (2) of mobile vehicle for bathing and entertainment purposes according to any of claims 1-4 characterised in that it comprises curved walls (f), it comprises at least one floodspace (w), the same number of swinging gates (s) and grilled protective casings (d) as the floodspaces (w), it also comprises water deflecting lamellae (b), and return channels of flood spaces (cs), where the curved wall (f) of the pool (m) is of an inwards curving shape forming a semicircle, which water deflecting curved wall (f) is connected to the floodspace (w) through a swinging gate (s), the swinging gate (s) automatically opens and lets the water from the pool (m) flow only in the direction of the floodspace (w), the floodspace (w) is covered with grilled protective casing (d), the return channels of flood space (cs) are on the right and left sides of the pool (m).

6. Water flow and sway controlling unit (3) of mobile vehicle for bathing and entertainment purposes according to any of claims 1-5 characterised in that it consists of water outlet channels (n), water inlet channels (k), high pressure pumps (sz), flexible ducts (l), valves (j), it comprises surge tanks (t), the water outlet channels (n) are set at the lower third of the front, back or side walls of the pool (m), the pool (m) is fit with at least one protective grille (r), the protective grilles (r) cover the water outlet channels (n) and the water inlet channels (k), the water inlet channels (k) are located on the bottom plate of the pool (m), the water outlet channels (n) are connected to the surge tank (t) through flexible ducts (l) and valves (j), the water inlet channels (k) are connected to the surge tank (t) through high pressure pumps (sz) and flexible ducts (l).

7. Central control unit (v) of mobile vehicle for bathing and entertainment purposes according to any of claims 1-6 characterised in that it comprises at least one water-level, water temperature, air temperature sensor (5), it comprises at least one acceleration, deceleration, tilt signaller (9), it comprises a gyroscope, it comprises at least one computer, it comprises computer programs, relays, electrical wires, where the sensors (5) and the signallers (9) are connected to the in-ports of the computer, the computer controls the high pressure pumps (sz), the valves (j), the cylinders (h), the water-heating and water-cooling units.

8. Water-level controlling system (6) of mobile vehicle for bathing and entertainment purposes that comprises pool moving unit (1), flood diverting unit (2), water flow and sway controlling unit (3) and central control unit (v) characterised in that the pool moving unit (1), the flood diverting unit (2), and the water flow and sway controlling unit (3) are operated in hierarchical order depending on the strength of the water surge, controlled by the central control unit (v), where the first phase is diverting the flowing water into the flood diverting unit (2), at the same time the pool (m) is tilted by the pool moving unit (1), in the second phase the remaining water surge is diverted by means of the water flow and sway controlling unit (3).

9. Method for application of mobile vehicle for bathing and entertainment purposes according to any of claims 1-8, which method serves to transport people in a vehicle-mounted pool (m) filled with water as well as to provide hydromassage, the said vehicle is used for entertainment, sightseeing, characterised in that the pool (m) is filled with water, the pool (m) comprises at least one high pressure water jet foot- and back massage appliance, the pool (m) also comprises at least one high pressure air injecting system, a Jacuzzi, the pool (m) is provided with equipment to heat and cool water, the vehicle is equipped with tables and chairs as well as units for storing food and beverages, the vehicle is equipped with changing room, shower room, locker and lavatory, and when the mobile vehicle for bathing and entertainment purposes is on the move, the water-level control of the pool (m) is ensured by the water-level controlling system (6).

10. Method for application of pool moving unit (1) according to claim 4 characterised in that the signals of the sensors (5) and signallers (9) are sent to the central control unit (v), which central control unit (v) is used to control the cylinders (h), which cylinders (h) move the object carrier (x) by means of the longitudinal axis (u) and the cross axis (z), allowing the pool (m) fixed on the object carrier (x) to tilt in three dimensions, thus preventing the swaying motion of the water caused by the changes of movement of the vehicle due to the road and traffic conditions.

11. Method for application of flood diverting unit (2) according to claim 5 characterised in that the water surging due to the movement of the vehicle is channelled into the floodspace (w) through the swinging gate (s), the water is forced to change direction by the curved water deflecting lamellae (b), and the water is returned back into the middle part of the pool (m) through the return channels of flood space (cs) on the right and left sides of the floodspace (w).

12. Method for application of water flow and sway control unit (3) according to claim 6 characterised in that the valves (j) are opened to adjusted diameter and time interval at the signal of the central control unit (v), directing the water from the pool (m) through the water outlet channels (n) into the surge tanks (t) in the case of water surging due to road and traffic conditions, the water is immediately pumped back into the pool (m) by means of high pressure pumps (sz) through the water inlet channels (k).
